(19) United States
(12) Patent Application Publication
(10) Pub. No.: US 2025/0308195 A1
(43) Pub. Date: Oct. 2, 2025

(54) SYSTEM AND METHOD FOR MONITORING FIELD EQUIPMENT

(71) Applicant: Niosense Inc., Laval (CA)

(72) Inventors: Patrick Lauzière, Laval (CA); David Préville, Laval (CA); Derreck Bélair, Laval (CA)

(21) Appl. No.: 19/086,835

(22) Filed: Mar. 21, 2025

Related U.S. Application Data
(60) Provisional application No. 63/570,645, filed on Mar. 27, 2024.

(51) Int. Cl. G06V 10/40; G08G 1/087

(52) U.S. Cl. CPC G06V 10/40; G08G 1/087

(57) ABSTRACT

Described are various embodiments of a system and method for monitoring field equipment. In one embodiment, the system comprises one or more cameras, each camera configured to acquire one or more images of one or more visually detectable elements, the visual detectable elements comprising at least one field equipment status indicator. The system further includes a processor and a memory communicatively coupled to the one or more cameras and operable to receive the acquired images therefrom, and analyze the one or more images to extract information related to the field equipment. In some embodiments, the processor transmits the information to a central system via a network. In some embodiments, the field equipment is within a traffic control cabinet and the central system uses the information to remotely activate one of the actionable subsystems, such as traffic lights or barriers, to minimize a number of stops made by the vehicle.

### CROSS-REFERENCE TO RELATED APPLICATIONS

This application claims the benefit of U.S. Provisional Application No. 63/570,645, filed Mar. 27, 2024, which is incorporated herein by reference in its entirety.

### FIELD OF THE DISCLOSURE

The present disclosure relates to control system monitoring, and, in particular, to a system and method for monitoring field equipment.

### BACKGROUND

Field equipment systems are an integral part of many control systems. In many fields, there is a central monitoring facility or data hub that allows operators to take action and determine if the action taken has resulted in changes in the field.

With the advent of artificial intelligence, accessing field equipment and obtaining relevant information timely is key to creating efficient feedback loops and making sure that the selected strategy is based on field data and not only on anticipated results based on historical data. However, field equipment is not always up to date or up to par with data interchange requirements to allow real-time statuses to be shared timely and accurately provide feedback when a central control system is responsible for proper operation of said field equipment.

This background information is provided to reveal information believed by the applicant to be of possible relevance. No admission is necessarily intended, nor should be construed that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a system and method for monitoring field equipment status that provides a means to monitor field equipment without having to replace or add sensors and/or network-enabled components. It provides an advantageous way to retrofit older equipment and allow monitoring and feedback via a network connected centralized control system.

In accordance with a first aspect, there is provided a system for monitoring field equipment comprising: one or more cameras, each camera configured to acquire one or more images of one or more visually detectable elements, the visual detectable elements comprising at least one field equipment status indicator; a processor and a memory communicatively coupled to the one or more cameras and operable to receive the acquired images therefrom; wherein the processor is further configured to analyze the one or more images to extract therefrom information related to the field equipment.

In some embodiments, the processor is further configured to: transmit, via a network, the information to a central system.

In some embodiments, the equipment status indicator comprises a dial, a display, or a screen of the field equipment.

In some embodiments, the visually detectable elements further comprise elements of the environment surrounding the field equipment.

In some embodiments, said analyzing the one or more images is done via one or more machine vision algorithms.

In some embodiments, the field equipment is located within a vehicle.

In some embodiments, the central system is communicatively coupled to a plurality of actionable subsystems, and wherein the information is used by the central system to remotely activate one of the actionable subsystems to minimize a number of stops made by the vehicle.

In some embodiments, the actionable subsystems comprise at least one of: a traffic light or a barrier.

In accordance with another aspect, there is provided a computer-implemented method for monitoring field equipment, comprising the steps of: acquire, via one or more cameras, one or more images of one or more visually detectable elements, the visual detectable elements comprising at least one equipment status indicator; send the one or more images to a processor coupled to a memory; and analyze, by the processor, the one or more images to extract therefrom information related to the field equipment.

In some embodiments, the method further comprises the step of: transmitting, by the processor via a network, the information to a central system.

In some embodiments, the equipment status indicator comprises a dial, a display, or a screen of the field equipment.

In some embodiments, the visually detectable elements further comprise elements of the environment surrounding the field equipment.

In some embodiments, said analyzing the one or more images is done via one or more machine vision algorithms.

In some embodiments, the field equipment is located within a vehicle.

In some embodiments, the central system is coupled to a plurality of actionable subsystems, and wherein the information is used by the central system to remotely activate one of the actionable subsystems to minimize a number of stops made by the vehicle.

In some embodiments, the actionable subsystems comprise at least one of: a traffic light or a barrier.

In some embodiments, the one or more cameras are installed within a traffic control cabinet, the traffic control cabinet operatively coupled to one or more traffic lights; and wherein the equipment status indicator comprises a status of said one or more traffic lights.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 is a schematic diagram of a system for monitoring field equipment status, in accordance with one embodiment;

FIG. 2, FIG. 3 and FIG. 4 are schematic diagrams illustrating different implementations of the system of FIG. 1, in accordance with different embodiments;

FIG. 5 is a front view of some components of the system of FIG. 1, in accordance with one embodiment; and

FIG. 6 is a schematic diagram illustrating a computing device used by different components of the system of FIG. 1, in accordance with one embodiment; and

FIG. 7 is a schematic diagram illustrating an exemplary embodiment of the system of FIG. 1 for monitoring the status of one or more traffic lights, in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

The present disclosure is directed to, in accordance with different embodiments, a system that provides reliable, constant and timely feedback on multiple control system elements without having to design customized sensors or implement multiple measurement devices in the field.

The present disclosure provides a means of monitoring any type of field equipment without having to retrofit older analogue equipment or equipment that may not or should not be communicatively coupled to a network. In one non-limiting example, remote pumping stations are controlled mainly using standard, industrial automation systems widely available today. Usually, most valves and controls in those stations are connected to the control system and can properly be assessed and actuated. But for obvious safety and security reasons, more often than not some manual bypass valve, locking mechanism or other safety systems are put in place that require the presence of a person to actuate and monitor. The position of said manual devices is impossible to determine remotely, unless specific sensors are implemented and monitored (limit switches or others). Adding these sensors is costly, time consuming and may not include all the relevant manual systems. On top of that, since they are not used often, they may age erratically and not properly perform their functions when they are required the most. Another example can be given with traffic control systems. Most legacy systems operate with traditional relays called load switches, connected to a controller that does not offer any communications link to share the status of traffic signals. In the absence of real-time information regarding traffic signals operated with a local controller, it becomes difficult if not impossible to remotely optimize multiple traffic signals using algorithms or artificial intelligence, limiting the performance of the whole network of traffic controllers with direct or indirect performance ties to a specific intersection. This is due to many factors including possible controller clock drifting, local controller inputs such as vehicle or pedestrian detectors that provoke timing changes, or to local failures of the controller.

From the examples above, it will be appreciated that the expression “field equipment” or “field systems” in the present disclosure should be understood to include any kind of control and/or sensing equipment that is located physically near or is attached to an apparatus/device/vehicle which it controls/monitors (e.g., not located remotely from the equipment being monitored). Examples include control/monitoring equipment coupled to industrial/manufacturing equipment, vehicles including heavy vehicles like trucks or the like. Sometimes field systems provide some form of feedback and control; sometimes they do not provide feedback at all but can still receive control inputs; and sometimes they do not offer any means of communication or remote control.

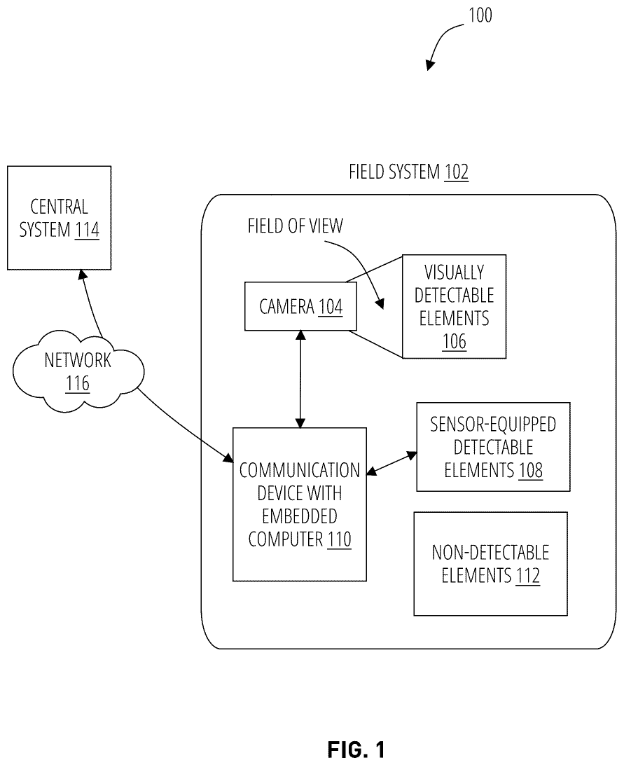

FIG. 1 shows an exemplary system 100 for monitoring field equipment. In this example, the system comprises, installed in close physical proximity to a field system 102 or within a same enclosed space encompassing the field system 102, a plurality of connected components. These may include one or more cameras 104, each camera 104 configured to acquire one or more images within a designated field of view one or more visually detectable elements 106 of the field system 102. The field system 102 may further comprise one or more sensor-equipped detectable elements 108 configured to acquire or measure equipment-related data. In some embodiments, the cameras 104 and the sensor-equipped detectable elements 108 may be communicatively coupled to a communication device 110 comprising an embedded computer configured to receive and, in some embodiments, process, data from the cameras 104 and the sensor-equipped detectable elements 108. The field system 102 may further comprise a number of non-detectable elements 112. The communication device 110 is typically communicatively coupled to a central system 114 such as a server or the like via a network 116, and configured to send the equipment-related data thereto. The central system 114 typically may comprise one or more servers configured to run software operable to process the received equipment-related data to generate outcomes and/or provide feedback.

In some embodiments, the images acquired by the one or more cameras may be analyzed or processed via one or more machine learning algorithms, such as machine vision algorithms to extract per pixel information from the visually detectable elements 106. The analysis may be performed using software located on the communication device and/or the central system 114, according to various embodiments that will be apparent to the person skilled in the art.

Information obtained from the image analysis software may include information in the form of text, numbers, images from displays, screens, dials, indicators or the like present within the field of view of the cameras 104. In one non-limiting example, the system 100 may be installed within a cabin or cabinet of a vehicle, such as a delivery truck, with one or more cameras configured to monitor the vehicle's dashboard and/or exterior views (front, rear, side views, etc.).

In some embodiments, the software may perform per-pixel analysis on the acquired images to determine a map traffic status based on in-cabinet indicators and use the results to determine the performance of a stop avoidance system. Examples of such stop avoidance systems may include, without limitation, the vehicle stop avoidance system disclosed in U.S. patent application Ser. No. 18/305,583, the entirety of which is incorporated by reference. The stop avoidance system may be configured to minimize a number of avoidable stops made by a vehicle along a path or route, the path comprising a plurality of actionable subsystems thereon, for example traffic lights, barriers or the like that may force the vehicle to momentarily stop in proximity thereof. These actionable subsystems may be remotely activated/deactivated or in other cases the operation thereof can be influenced or changed via a plurality of requests thereto, for example by having a traffic light change at the right moment to avoid the vehicle stopping at the intersection.

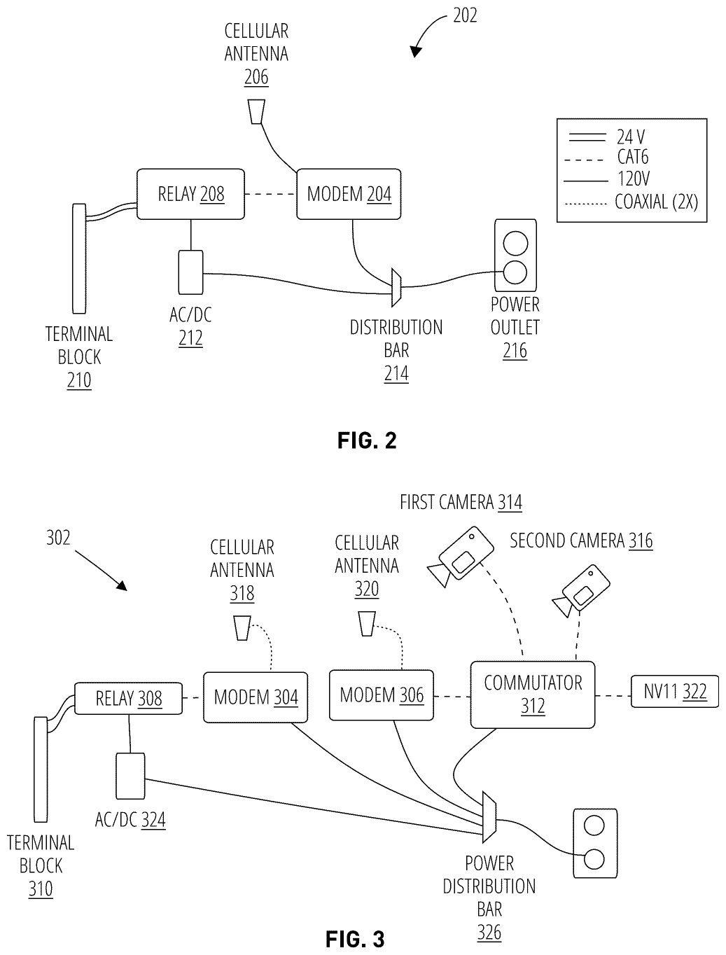

FIGS. 2 to 4 show different implementations or embodiments of the system described above in the context of monitoring vehicles. The lines in FIGS. 2-4 represent different types of coupling wires or cables, as shown in the legend of FIG. 4.

The exemplary embodiment 202 of FIG. 2 comprises a communication device in the form of a single modem 204 coupled to a cellular antenna 206 and to a relay 208. The relay is itself coupled to a terminal block 210 and to an AC/DC converter 212. Both the converter 212 and model 204 are electrically coupled to a same distribution bar 214 electrically coupled to a power outlet 216. The cellular antenna 206 provides the communication link with a central system.

FIG. 3 shows another exemplary embodiment 302. In this example, two modems are used, a first modem 304 and a second modem 306. The first modem 304 is communicatively coupled to the relay 308, itself coupled to the terminal block 310. The commutator 312 is coupled to a first camera 314 and a second camera 316, each camera configured to acquire images from a different field of view. In some embodiments, camera 314 may be configured to acquire images from the exterior of the cabinet (e.g., immediate surrounding environment, including roads, road-side equipment, presence of other vehicles and/or pedestrians, etc.), while camera 316 may be configured to acquire images from the interior (e.g., driver and dashboard). Each modem 304 and modem 306 may be individually coupled to a corresponding cellular antenna 318 or 320, respectively. In some embodiments, the commutator 312 may be coupled to one or more processing units, such as a NV11 GPU unit NV11 322 or the like, to perform real-time or near real-time image analysis of the images acquired by the cameras. The relay 308 is coupled to a AC/DC converter AC/DC 324. The cameras, converter, commutator are all electrically coupled to a power distribution bar 326 itself coupled to an electrical outlet or power source.

FIG. 4 shows another exemplary embodiment 402, comprising a single modem 404 coupled to a cellular antenna 406, and the commutator 408. The commutator 408 is itself coupled to a first camera 410 and a second camera 412, and to a GPU 414. The commutator 408 and the modem 404 are both electrically coupled to a distribution bar 416 which is itself coupled to an electrical outlet or a power source.

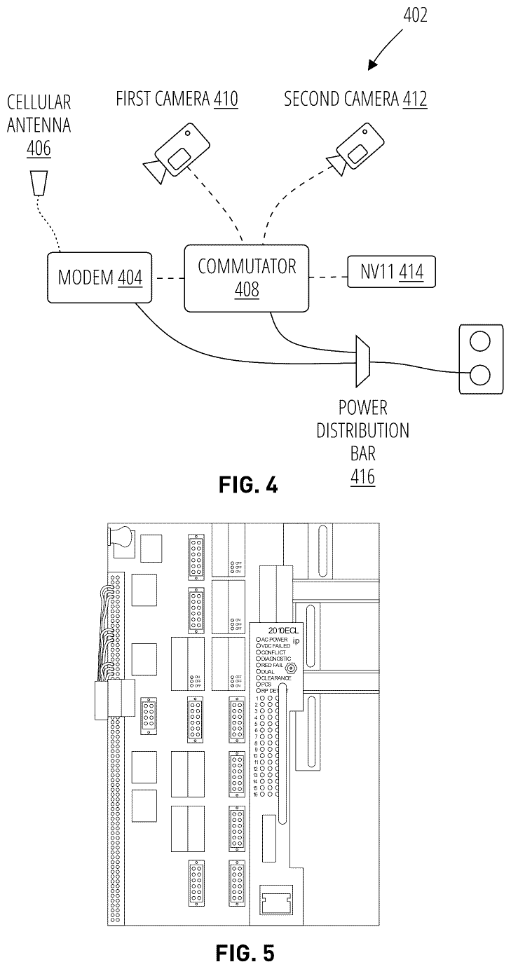

FIG. 5 is a photograph of an exemplary embodiment of the field equipment monitoring system, showing different component described above installed inside a traffic control cabinet.

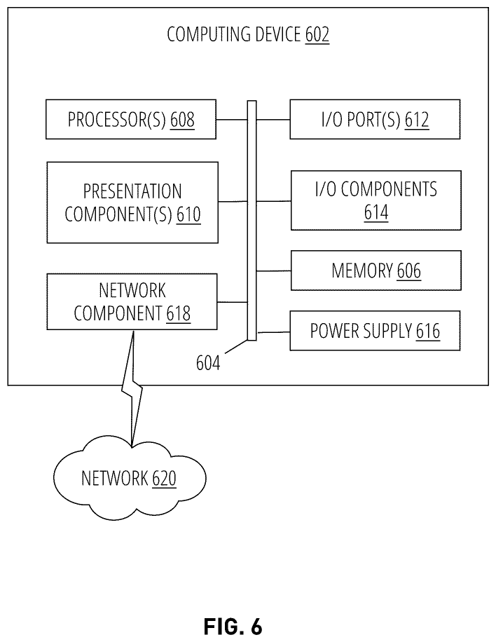

FIG. 6 is a block diagram of an example computing device for implementing aspects disclosed herein, such as the central system 114 and/or communication device with the embedded computer 110, and is designated generally as the computing device 602. The computing device 602 is but one example of a suitable computing environment and is not intended to suggest any limitation as to the scope of use or functionality of various embodiments. Neither should the computing device 602 be interpreted as having any dependency or requirement relating to any one or combination of components and/or modules illustrated.

The examples and embodiments disclosed herein may be described in the general context of computer code or machine-useable instructions, including computer-executable instructions such as program components, being executed by a computer or other machine. Generally, program components including routines, programs, objects, components, data structures, and the like, refer to code that performs particular tasks, or implement particular abstract data types. The disclosed examples can be practiced in a variety of system configurations, including personal computers, laptops, smart phones, mobile tablets, hand-held devices, consumer electronics, specialty computing devices, etc. The disclosed examples can also be practiced in distributed computing environments, where tasks are performed by remote-processing devices that are linked through a communications network.

The computing device 602 includes a bus 604 that directly or indirectly couples the following devices: memory 606, one or more processors 608, one or more presentation components 610, input/output (I/O) ports 612, I/O components 614, a power supply 616, and a network component 618. The computing device 602 should not be interpreted as having any dependency or requirement related to any single component or combination of components illustrated therein. While the computing device 602 is depicted as a single device, multiple computing devices 602 can work together and share the depicted device resources. For instance, the memory 606 can be distributed across multiple devices, the processor(s) 608 can be housed on different devices, and so on.

The bus 604 represents a system bus that can be any of several types of bus structures, including a memory bus or memory controller, a peripheral bus, and a local bus using any of a variety of bus architectures.

Although the various blocks of FIG. 6 are shown with lines for the sake of clarity, delineating various components is more accurately grey and fuzzy. For example, one can consider a presentation component such as a display device to be an I/O component. Also, processors have memory. Such is the nature of the art, and the diagram of FIG. 6 is merely illustrative of an exemplary computing device that can be used in connection with one or more embodiments. Distinction is not made between such categories as “workstation,” “server,” “laptop,” “hand-held device”, “embedded computer”, etc., as all are contemplated within the scope of FIG. 6 and the references herein to a “computing device.”

The memory 606 can be used to store and access instructions configured to carry out the various operations disclosed herein. In some examples, the memory 606 includes computer-readable media in the form of volatile and/or nonvolatile memory, removable or non-removable memory, data disks in virtual environments, or a combination thereof.

The memory 606 stores, among other data, one or more applications. The applications, when executed by the processor(s) 608, operate to perform functionality on the computing device 602. The memory 606 further stores one or more computer-executable components. Exemplary components can include a user interface component.

By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer. Computer storage media does not, however, include propagated signals. Rather, computer storage media excludes propagated signals. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory includes computer storage media in the form of volatile and/or nonvolatile memory such as read only memory (ROM) and random-access memory (RAM). A basic input/output system (BIOS), containing the basic routines that help to transfer information between elements within computer, such as during start-up, is typically stored in ROM. RAM typically contains data and/or program modules that are immediately accessible to and/or presently being operated on by a processing unit or processor.

The computer can also include other removable/non-removable, volatile/nonvolatile computer storage media, such as, for example only, a hard disk drive that reads from or writes to non-removable, nonvolatile magnetic media, a universal serial bus (USB) port that provides for reads from or writes to a removable, nonvolatile memory, and an optical disk drive that reads from or writes to a removable, nonvolatile optical disk such as a CD ROM or other optical media. Other removable/non-removable, volatile/nonvolatile computer storage media that can be used in an exemplary operating environment include, but are not limited to, magnetic tape cassettes, flash memory cards, digital versatile disks, digital video tape, solid state RAM, solid state ROM, and the like. The hard disk drive is typically connected to the system bus through a non-removable memory interface, and a USB port and optical disk drive are typically connected to the system bus by a removable memory interface.

The processor(s) 608 can include any quantity of processing units that read data from various entities, such as the memory 606 or the I/O components 614. Specifically, the processor(s) 608 are programmed to execute computer-executable instructions for implementing aspects of the disclosure, such as to perform the image analysis as described herein. The instructions can be performed by the processor, by multiple processors within the computing device 602, or by a processor external to the computing device 602. In some examples, the processor(s) 608 are programmed to execute instructions. Moreover, in some examples, the processor(s) 608 represent an implementation of analog techniques to perform the operations described herein. For example, the operations can be performed by an analog client computing device and/or a digital client computing device.

The presentation component(s) 610 present data indications to a user or other device. Exemplary presentation components include a display device, speaker, printing component, vibrating component, etc. One skilled in the art will understand and appreciate that computer data can be presented in a number of ways, such as visually in a graphical user interface (GUI), audibly through speakers, wirelessly between computing devices 602, across a wired connection, or in other ways.

The ports 612 allow the computing device 602 to be logically coupled to other devices including the I/O components 614, some of which can be built in. Examples of the I/O components 614 include, for example but without limitation, a microphone, keyboard, mouse, joystick, game pad, satellite dish, scanner, printer, wireless device, etc.

In some examples, the network component 618 includes a network interface card and/or computer-executable instructions (e.g., a driver) for operating the network interface card. Communication between the computing device 602 and other devices can occur using any protocol or mechanism over any wired or wireless connection. In some examples, the network component 618 is operable to communicate data over public, private, or hybrid (public and private) networks 620 using a transfer protocol, between devices wirelessly using long range communication technologies (e.g., cellular networks, etc.) and/or short range communication technologies (e.g., near-field communication (NFC), BLUETOOTH® branded communications, or the like), or a combination thereof.

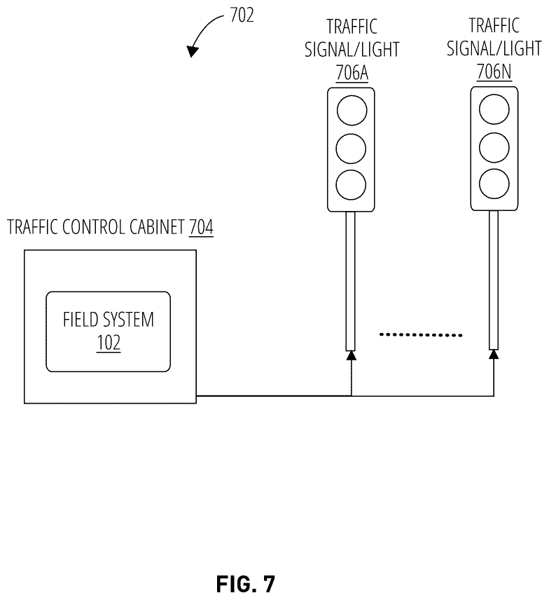

In some embodiments, as schematically illustrated in FIG. 7, the field system 102 described above may be used in the context of traffic control of actionable subsystems such as traffic lights. FIG. 7 provides a non-limiting example of such an embodiment 702 where the field system 102 (including the one or more cameras 104) is installed in a traffic control cabinet 704. In this example, at least one of the one of more cameras 104 is configured to acquire images of visually detectable elements indicative of the status of one or more traffic lights 706A-706N. This information is used by the one or more machine-learning algorithms and stop avoiding systems to optimize the traffic lights/signals to facilitate movement of heavy vehicles. In some embodiments, traffic lights 706A-706N are consecutively positioned.

A computer, or computing device, as used herein, represents any device executing instructions (e.g., as application programs, operating system functionality, or both) to implement the operations and functionality as described herein. The computing device can include a mobile computing device or any other portable device. In some examples, the mobile computing device includes a mobile telephone, laptop, tablet, computing pad, netbook, gaming device, wearable device and/or portable media player. Additionally, the computing device can represent a group of processing units or other computing devices.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A system for monitoring field equipment comprising:
one or more cameras, each camera configured to acquire one or more images of one or more visually detectable elements, the visual detectable elements comprising at least one field equipment status indicator;
a processor and a memory communicatively coupled to the one or more cameras and operable to receive the acquired images therefrom;
wherein the processor is further configured to analyze the one or more images to extract therefrom information related to the field equipment.

2. The system of claim 1, wherein the processor is further configured to:
transmit, via a network, the information to a central system.

3. The system of claim 2, wherein the equipment status indicator comprises a dial, a display, or a screen of the field equipment.

4. The system of claim 2, wherein the visually detectable elements further comprise elements of the environment surrounding the field equipment.

5. The system of claim 2, wherein said analyzing the one or more images is done via one or more machine vision algorithms.

6. The system of claim 1, wherein the field equipment is located within a vehicle.

7. The system of claim 6, wherein the central system is communicatively coupled to a plurality of actionable subsystems, and wherein the information is used by the central system to remotely activate one of the actionable subsystems to minimize a number of stops made by the vehicle.

8. The system of claim 7, wherein the actionable subsystems comprise at least one of: a traffic light or a barrier.

9. A computer-implemented method for monitoring field equipment, comprising the steps of:
acquire, via one or more cameras, one or more images of one or more visually detectable elements, the visual detectable elements comprising at least one equipment status indicator;
send the one or more images to a processor coupled to a memory; and
analyze, by the processor, the one or more images to extract therefrom information related to the field equipment.

10. The computer-implemented method of claim 9, further comprising the step of:
transmitting, by the processor via a network, the information to a central system.

11. The computer-implemented method of claim 10, wherein the equipment status indicator comprises a dial, a display, or a screen of the field equipment.

12. The computer-implemented method of claim 10, wherein the visually detectable elements further comprise elements of the environment surrounding the field equipment.

13. The computer-implemented method of claim 10, wherein said analyzing the one or more images is done via one or more machine vision algorithms.

14. The computer-implemented method of claim 10, wherein the field equipment is located within a vehicle.

15. The computer-implemented method of claim 10, wherein the central system is coupled to a plurality of actionable subsystems, and wherein the information is used by the central system to remotely activate one of the actionable subsystems to minimize a number of stops made by the vehicle.

16. The computer-implemented method of claim 15, wherein the actionable subsystems comprise at least one of: a traffic light or a barrier.

17. The system of claim 1, wherein the one or more cameras and the processor are located within a traffic control cabinet, the traffic control cabinet operatively coupled to one or more traffic lights.

18. The computer-implemented method of claim 9, wherein the one or more cameras are installed within a traffic control cabinet, the traffic control cabinet operatively coupled to one or more traffic lights; and
wherein the equipment status indicator comprises a status of said one or more traffic lights.
